(19) United States
(12) Patent Application Publication
(10) Pub. No.: US 2015/0177821 A1
(43) Pub. Date: Jun. 25, 2015

(54) Multiple Execution Unit Processor Core

(71) Applicant: Broadcom Corporation, Irvine, CA (US)

(72) Inventors: Ramesh Senthinathan, Cupertino, CA (US); Kenneth Yeager, Sunnyvale, CA (US); Jason Alexander Leonard, Los Altos, CA (US); Lief O'Donnell, Albany, CA (US); Michael Belhazy, Sunnyvale, CA (US)

(73) Assignee: BROADCOM CORPORATION, Irvine, CA (US)

(21) Appl. No.: 14/202,910

(22) Filed: Mar. 10, 2014

Related U.S. Application Data
(60) Provisional application No. 61/919,477, filed on Dec. 20, 2013.

(51) Int. Cl. G06F 1/32; G06F 9/30

(52) U.S. Cl. CPC G06F 1/3293; G06F 9/30189

(57) ABSTRACT

A processor core includes multiple execution units, such as a first execution unit and a second execution unit. The first execution unit may include a first functional component that supports a superscalar pipeline. The second execution unit may include a second functional component supporting a scalar pipeline. The processor core may operate in a high-performance mode by using the first execution unit and powering down the second execution unit and operate in a low-power mode by using the second execution unit and powering down the first execution unit. The processor core may include common elements shared between the multiple execution units, such as a common instruction cache, data cache, register file(s), and more.

### CROSS REFERENCE TO RELATED APPLICATIONS

This application claims priority to provisional application Ser. No. 61/919,477, filed Dec. 20, 2013, which is incorporated by reference in its entirety.

### TECHNICAL FIELD

This disclosure relates to processor cores. This disclosure also relates to a processor core with multiple execution units.

### BACKGROUND

Rapid advances in electronics and communication technologies, driven by immense customer demand, have resulted in the widespread adoption of mobile communication devices. Many of these devices, e.g., smartphones, have sophisticated processing capability that performs many different processing tasks, e.g., decoding and playback of encoded audio files. In most devices, energy consumption is of interest, and reduced energy consumption is a design goal.

### BRIEF DESCRIPTION OF THE DRAWINGS

FIG. 1 shows an example of electronic device that includes a processor core with multiple execution units.

FIG. 2 shows an exemplary architecture for a processor core that includes multiple execution units.

FIG. 3 shows another exemplary architecture for a processor core that includes multiple execution units.

FIG. 4 shows an example pipeline that a processor core may implement.

FIG. 5 shows an example pipeline that a processor core may implement.

FIG. 6 shows an example of logic that the electronic device may implement.

### DETAILED DESCRIPTION

The techniques and systems below describe a processor core architecture that may facilitate increased flexibility between power-consumption and performance. The processor core described below may use high-performance circuitry to execute computationally intensive instructions or threads, and use lower-power circuitry at other times to reduce power consumption by the processor core. The architecture may reduce delays in transferring processor state when the processor core transitions between use of high-performance circuitry and use of low power circuitry. Efficiencies in transferring processor state may result in further reductions in power consumption by lessening the amount of memory transferred or the physical distance the memory is transferred.

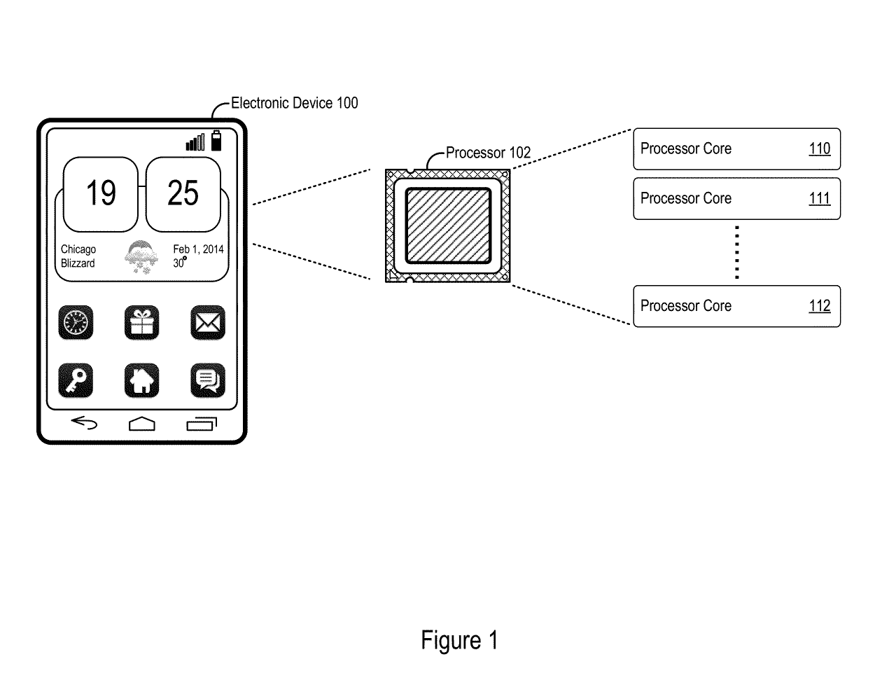

FIG. 1 shows an example of an electronic device 100 that includes a processor core with multiple execution units. The electronic device 100 may take any number of forms. In FIG. 1, the electronic device 100 is a cellular telephone. As additional examples, the electronic device 100 may be laptop, desktop, or other type of computer, a personal data assistant, tablet device, a portable email device, television, stereo equipment such as amplifiers, pre-amplifiers, and tuners, a home media device such as compact disc (CD)/digital versatile disc (DVD) players, portable MP3 players, high definition (e.g., Blu-Ray™ or DVD audio) media players, or home media servers. Other examples of electronic devices 100 include vehicles such as cars and planes, societal infrastructure such as power plants, traffic monitoring and control systems, or radio and television broadcasting systems. Further examples include home climate control systems, washing machines, refrigerators and freezers, dishwashers, intrusion alarms, audio/video surveillance or security equipment, network attached storage, switches, network bridges, blade servers, and network routers and gateways. The electronic device 100 may be found in virtually any context, including the home, business, public spaces, or automobile. Thus, as additional examples, the electronic device 100 may further include automobile engine controllers, audio head ends, satellite music transceivers, noise cancellation systems, voice recognition systems, climate control systems, navigation systems, alarm systems, or countless other devices.

The electronic device 100 includes a processor 102. The processor 102 may include multiple processing cores, such as the processor cores labeled as 110-112 in FIG. 1. A processor core may refer to a computing unit that decodes, reads, and/or executes program instructions. In that regard, the processor cores 110-112 may be architecturally, logically, and physically distinct from one another. For example, software (e.g., an operating system) may view the processor cores 110-112 as distinct computing units to which the software may assign and schedule execution of program threads. The processor cores 110-112 may be physically separate, occupying distinct portions of a die or integrated circuit (IC) that implements the processor 102. A processor core may include a system interface through which the processor core interfaces with elements external to the processor core, such as a memory input/output (I/O) controller to an external memory, system busses in the electronic device 100, clock or timer logic, device I/O interfaces, and more.

A processor core, e.g., the processor core 110, may include multiple execution units. As described below, the multiple execution units may provide consistent functionality, but vary in performance, power-consumption, and/or energy consumption (e.g., power over a function of time) for performing a function. The processor core 110 may flexibly select particular execution units to use in instruction execution. The processor cores 110 may operate in different modes, dynamically powering on and powering down selected execution units according to power, energy, and/or performance requirements for the electronic device 100.

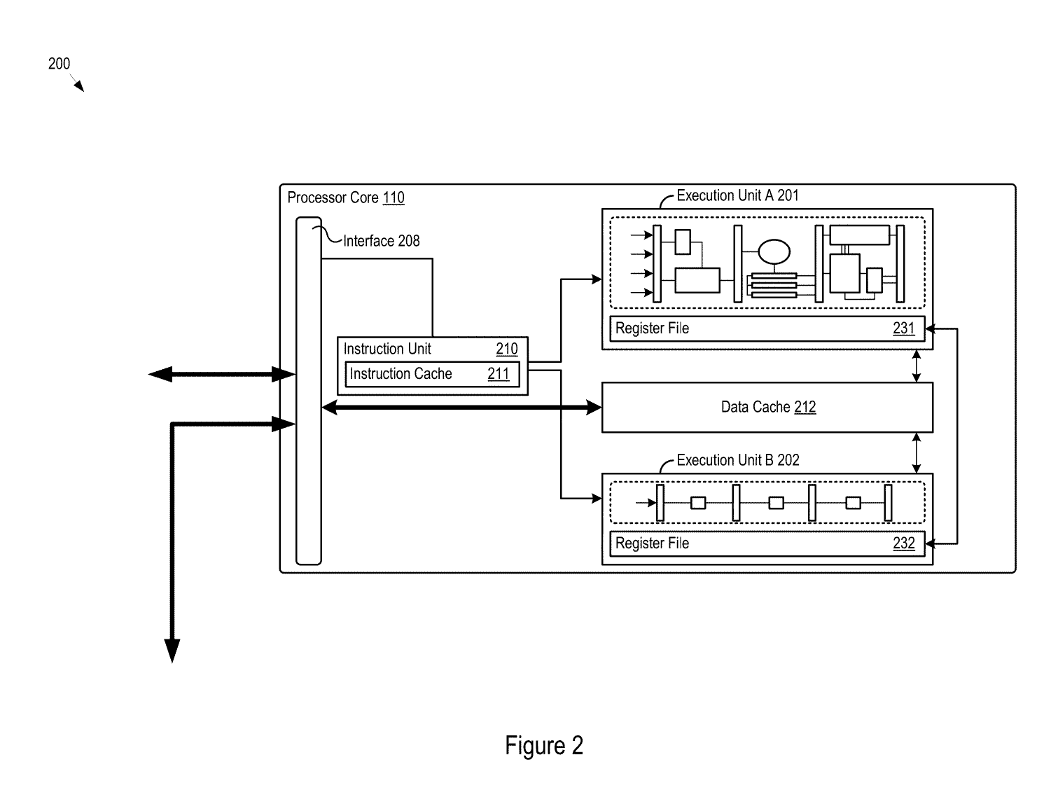

FIG. 2 shows an exemplary architecture 200 for a processor core 110 that includes multiple execution units. An execution unit may refer to any selected group of interconnected processing circuits. In particular, the processor core 110 in FIG. 2 includes the execution units labeled as execution unit A 201 and execution unit B 202. The processor core 110 may further include common components shared by the multiple execution units, including as examples the system interface 208, the instruction unit 210, the instruction cache 211, and the data cache 212. The instruction unit 210 may perform instruction fetching, instruction decoding, and/or instruction issuing functions. In that regard, the instruction unit 210 may issue instructions for execution by a selected execution unit of the processor core 110. The data cache 212 may be organized as a hierarchy of caches, and may include any data cache implemented in the processor core 110, e.g., a L1 and/or L2 cache implemented within the processor core 110. The processor core 110 may additionally implement a common interface to the data cache 212 shared between execution units, e.g., a common load/store datapath for accessing content arrays of an L1 or L2 cache.

Execution unit A 201 and execution unit B 202 may each include an execution pipeline for executing program instructions. In that regard, the execution units may provide similar, consistent, or identical functionality, but vary in performance and power-consumption. For example, execution unit B 202 may include similar functional components as execution unit A 201, such as a functionally similar arithmetic logic unit (ALU), integer register file, vector register file, load/store components, or operand mapping components. However, the execution units A 201 and B 202 may, in some variations, be different without functional overlap. The functional components implemented within execution unit B 202 may have lower power consumption characteristics that those implemented in execution unit A 201, e.g., lesser complexity, fewer entries, or fewer access (e.g., read or write) ports.

In some implementations, execution unit A 201 includes circuitry that implements a superscalar pipeline, providing out-of-order instruction execution that support issuing and executing multiple parallel instructions per cycle. Execution unit A 201 may include, for example, a dedicated register file 231 which may have an increased area to support multiple read and write ports and allow for feeding of operands and acceptance of results from multiple high-performance logic units in parallel. In some implementations, the execution unit A 201 may employ a register mapping algorithm to support aggressive out-of-order operation that uses an increased number of physical registers. The circuits within the execution unit A 201 may be interconnected with many signal connections with sensitive timing requirements.

Execution unit B 202 may include circuitry that implements a scalar pipeline, which consumes less power during operation than execution unit A 201. In that regard, execution unit B 202 may include a dedicated register file 232, which may be smaller and consumer less power than register file 231. For example, the register file 232 of execution unit B 202 may include fewer read and write ports, and a lesser number of registers supporting a smaller instruction window. Similarly, execution unit B 202 may include logic to execute load and store instructions with reduced complexity, which may reduce area and power consumption by more than half of similar logic implemented in execution unit A 201.

Thus, the processor core 110 may use execution unit A 201 to execute instructions to meet high-performance demands of the electronic device 100. When the electronic device 100 does not require increased-performance (e.g., when in a low-power or standby mode), the processor core 110 may power down the high-performance circuitry of execution unit A 201 and use execution unit B 202 instead, thus reducing the total dynamic power consumption of the processor core 110.

The processor core 110 may power down unused executions units. Powering down an execution unit may be accomplished by, for example, removing or disconnecting one or more operational voltage(s) normally applied to the particular components of the execution unit, asserting an enable input connected to control circuitry in the execution unit, by substantially reducing one or more operational voltage(s), or in other ways. During the time the unused execution unit of the processor core is powered-down, the unused execution unit consumes little, if any, power, and in particular, the leakage power loss attributable to the unused execution unit may be significantly reduced if not completely eliminated. As another example, the processor core 110 may power down an execution unit by placing the execution in a power-down mode, in which the execution unit may be placed in a lower power than nominal operating mode, a power off mode, or another mode that consumes less power than when the execution unit normally executes.

The processor core 110 may operate in multiple modes. When the processor core 110 operates in a first mode (e.g., a high-performance mode), the processor core 110 may use execution unit A 201 to execute instructions, while powering down execution unit B 202. Accordingly, the instruction unit 210 may issue instructions for execution by execution unit A 201 when the processor core 110 operates in the first mode. When the processor core 110 operates in a second mode (e.g., a low-power mode), the processor core 110 may use execution unit B 202 to execute instructions and power down execution unit A 201, thus reducing leakage power and dynamic power consumption. When the processor core 110 operates in the second operating mode, the instruction unit 210 may issue instructions to execution unit B 202.

The rate which instructions are issued by the instruction unit 210 may vary depending on the particular operating mode of the processor core 110. Execution unit A 201 may support a greater instruction issue rate than execution unit B 202, e.g., as measured in instructions per clock cycle. Thus, the instruction unit 210 may issue instructions at a first rate when the processor core 110 operates in the first operating mode and at a second rate when the processor core 110 operates in the second operating mode, where the first rate is greater than the second rate. In some variations, execution unit B 202 supports execution of a single instruction per cycle. In other variations, execution unit B 202 supports execution of multiple instructions per cycle (e.g., 2 instructions/cycle or 4 instructions/cycle). In yet another variation, execution unit B 202 may flexibly support execution of a particular number of instructions per cycle that vary depending on performance requirements.

The processor core 110 may transition between operating modes. In doing so the processor core 110 may transition issuing and execution of program instructions from execution unit A 201 to execution unit B 202, or vice versa. As part of the transition process, the processor core 110 may transition the processor state between execution units. Processor state may refer to data stored in memory elements at a particular point in time, including data accessible by the execution units to executing program instructions. By sharing multiple common memory elements, the processor core 110 may increase the speed and reduce the complexity of transitioning processor state. To illustrate, execution units A 201 and B 202 may share a common instruction cache 211 and data cache 212. Thus, the processor core 110 may transition the processor state between the execution units without having to flush or reload the instruction cache 211 and data cache 212, as both of these memory elements are already commonly accessible to the execution units A 201 and B 202.

In the example shown in FIG. 2, execution unit A 201 includes a dedicated register file, labeled as register file 231, and execution unit B 202 includes a dedicated register file, labeled as register file 232. In this exemplary architecture 200, the processor core 110 may transition the processor state between execution units by copying the register file contents from the dedicated register file of one execution unit to another. Thus, the processor core 110 may transition between operating modes without data flushing the data cache 212 or without performing memory transfers for either the instruction cache 211 or the data cache 212. Additionally, transitioning memory content between register files may be rapidly and efficiently accomplished, without having to transfer data across the system interface 208, across greater physical distances through system busses to an external processing element, or between different processor cores.

Thus, the processor core 110 may transition the processor state between execution units with reduced data amounts and reduced power consumption. Reduced power consumption may result because the data transfer occurs within the processor core 110 itself, and the physical distance between dedicated register files (or other applicable memory elements where processor state data is being transitioned) as well as the capacitive loading is reduced. In some exemplary architectures, an integer register file may contain 2 Kilobytes (KB) of data in a 32×64 bit configuration and a vector register file may contain 4 KB of data in a 32×128 bit configuration, and the processor core 110 may transfer processor state by transferring the register contents (e.g., 6 KB) of the integer register file and the vector register file. In this example, the processor core 110 may transfer the processor state without transferring contents from the instruction cache 211 (e.g., holding 32 KB of data) or data cache 212 (e.g., holding 32 KB of data). Additionally, by transferring the processor state within the processor core 110, e.g., as opposed to transferring to a different processor core, the processor core 110 may reduce complexities in data transfer, such as handshaking for transfer of large memory blocks and data transfer across physically longer wires.

As yet another benefit, implementing a commonly shared instruction cache 211 and/or data cache 212 may reduce the area of the processor core 110 as compared to multiple core implementations that include separate instruction and data caches. Sharing one or more common data caches in the processor core 110 may be particularly useful in contrast to architectures with separate processor cores that each implement L2 caches (or higher). Instead of two separate processor cores with two separate L2 caches, the processor core 110 may implement a common L2 cache shared by execution unit A 201 and execution unit B 202. Doing so may further increase efficiency in transitioning processor state, and reduce die or IC area needed to implement the processor core 110 in comparison to other designs.

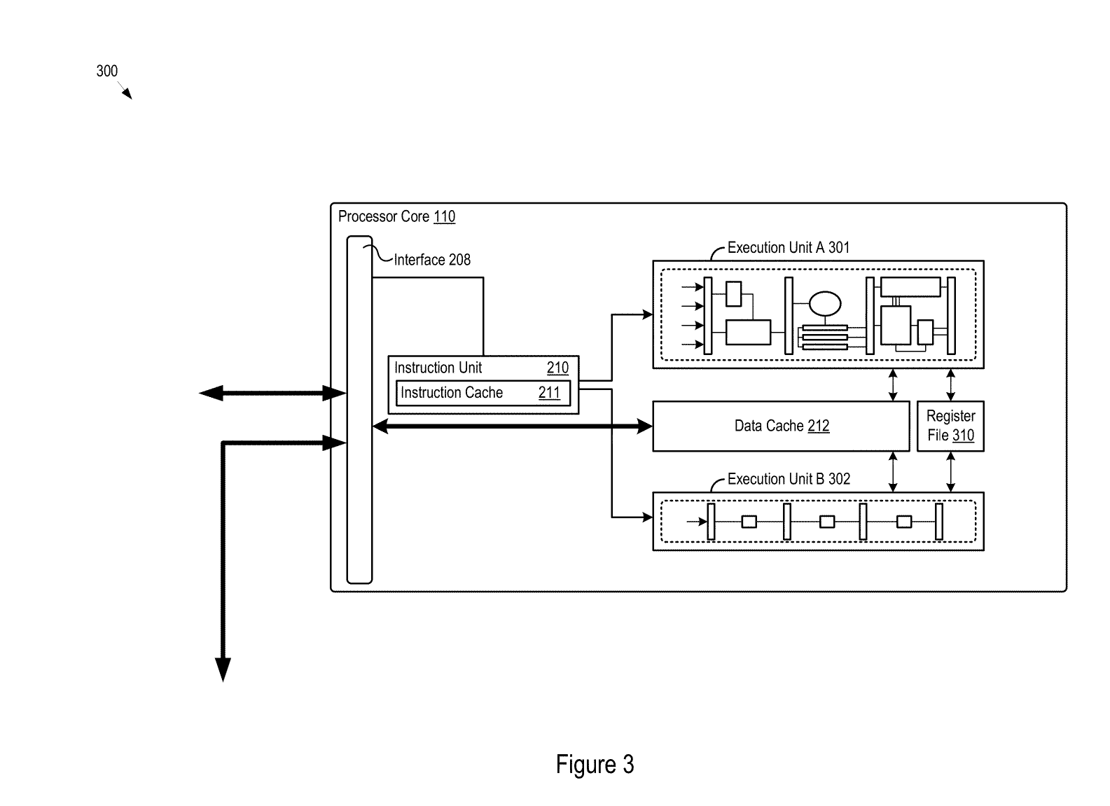

FIG. 3 shows another exemplary architecture 300 for a processor core 110 that includes multiple execution units. In FIG. 3, the processor core 110 includes the execution units labeled as execution unit A 301 and execution unit B 302. Execution unit A 301 may include high performance circuitry that implements a superscalar processor (or portions thereof) and execution unit B 302 may include low power circuitry that implements a simple scalar processor (or portions thereof).

The execution units A 301 and B 302 may share multiple common elements, including a common register file 310. In some variations, the processor core 110 implements a common set of memory elements storing processor state, such that processor state is commonly accessible to execution units within the processor core 110. Accordingly, the processor core 110 may transition between operating modes without any transfer of memory content between execution units, e.g., without having to transfer processor state.

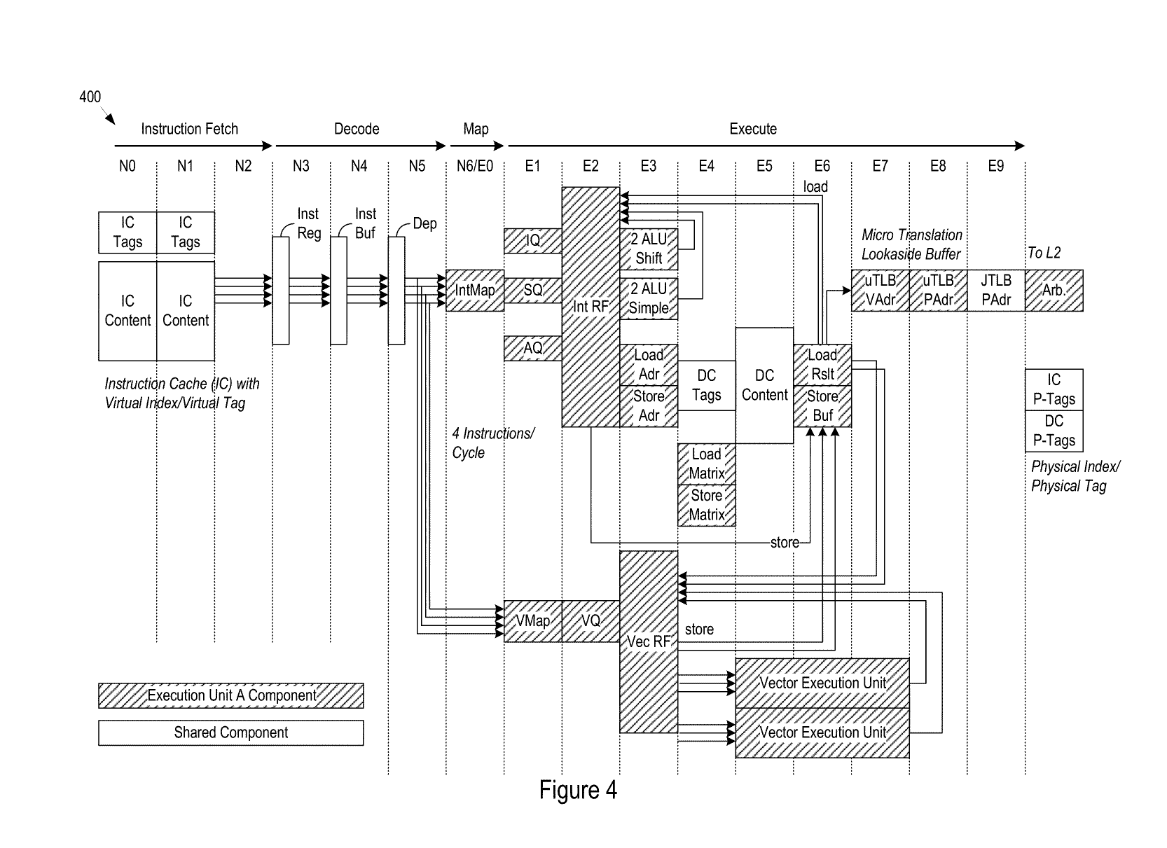

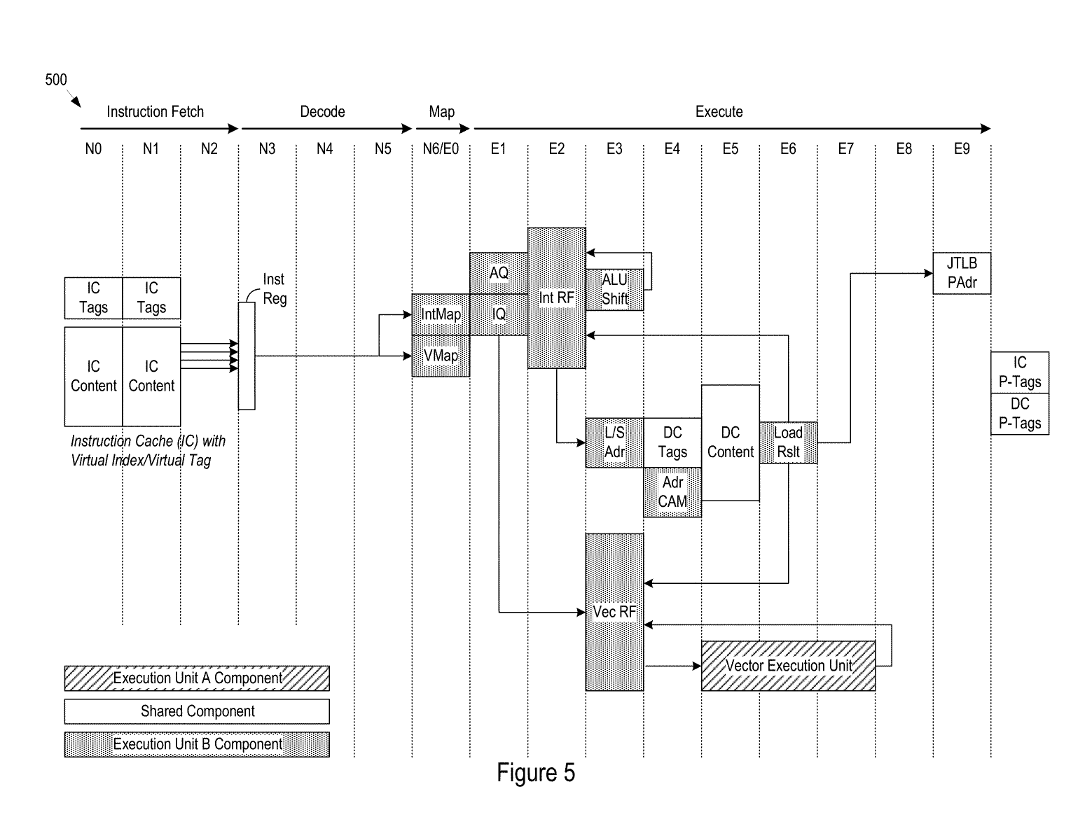

Execution units within a processor core 110 may differ in presence or number of particular functional components or in characteristics of functionally similar components. The varying configuration options between execution units in a processor core 110 are nearly endless, and one exemplary configuration of execution units is presented next in FIGS. 4 and 5. Table 1, which follows FIGS. 4 and 5, provides additional details as to the component configurations in the different execution units.

FIG. 4 shows an example pipeline 400 that a processor core 110 may implement. In particular, the processor core 110 may implement the exemplary pipeline 400 through a combination of high-performance execution unit (e.g., execution unit A 201 or 301) and common components shared with other execution units implemented within the processor core 110. In FIG. 4, the pipeline 400 includes instruction stages labeled as N0-N6 and execution stages labeled as E0-E9.

The instruction stages N0-N6 use shared components within the processor core 110. As seen in FIG. 4, the shared components include the instruction cache (IC) 211, which may support virtual index/virtual tags, an instruction register (Inst Reg), and an instruction buffer (Inst Buf). Other shared components in the pipeline 400 include the content and tags of the data cache (DC) 212 and a joint translation lookaside buffer (JTLB). The pipeline also includes multiple functional components specific to a high performance execution unit A 201 or 301, such as integer mapping logic (IntMap), an integer queue (IQ), simple queue (SQ), address queue (AQ), vector mapping logic (VMap), vector queue (VQ), integer register file (Int RF), vector register file (Vec RF), load and store matrices, ALUs, a store buffer (store Buf), a load result buffer (Load Rslt), vector execution units, micro translation lookaside buffer (uTBL) including virtual address (VAdr) and physical address (PAdr) components. The pipeline 400 may be a superscalar pipeline capable of supporting parallel issue of 4 instructions/cycle, for example

FIG. 5 shows an example pipeline 500 that a processor core 110 may implement. In particular, the processor core 110 may implement the exemplary pipeline 500 through a combination of a low-power execution unit (e.g., execution unit B 202 or 302) and common components shared with other execution units implemented within the processor core 110. In some variations, including the one shown in FIG. 5, the processor core 110 may implement the pipeline 500 to include one or more functional components from a different execution unit, e.g., high-performance execution unit A 201 or 301. In particular, the pipeline 500 includes a vector execution unit implemented in a different execution unit. When processing instructions using the pipeline 500, the processor core 110 may selectively power on a component from a different execution unit, e.g., the vector execution unit from execution unit A 201 or 301. The processor core 110 may specifically do so to execute a vector instruction using the pipeline 500, and otherwise power down the vector execution unit during pipeline stages where the vector execution unit is unused. As seen in FIG. 5, the pipeline 500 includes shared components as well as functional components specific to the low power execution unit B 202 or 302.

Table 1 below presents exemplary configurations for the pipeline 400 and 500.

TABLE 1

| Func- | | |
|---|---|---|
| tional | | |
| Compo- | Pipeline 400 | Pipeline 500 |
| nent | (High-Performance) | (Low-Power) |
| Instruc- | The pipeline 400 may | The pipeline 500 may share |
| tion | implement the IC with | the same instruction cache |
| Cache | multiple levels (e.g., 64 KB | as the pipeline 400. |
| (IC) | level-1 and 16 KB level-0). | |
| | An instruction register may | |
| | store multiple instructions in | |
| | parallel. | |
| Instruc- | The instruction buffer may | The pipeline 500 may use |
| tion | contain instructions in | the instruction register as |
| Buffer | multiple (e.g., 4) lanes. | the instruction buffer and |
| (Inst | Multiple (e.g., 8) instructions | select a next-oldest |
| Buf) | may be aligned and loaded | instruction each cycle. |
| | into the Inst Buf each cycle. | |
| Instruc- | Multiple (e.g., 4) instructions | The Pipeline 500 may handle |
| tion | presented to the map stage | one instruction per cycle and |
| align- | in parallel lanes. | complicated instructions may |
| ment | Complicated instructions may | be repeated on successive |
| and | be replicated on multiple | cycles. |
| replica- | lanes if the map stage cannot | |
| tion | handle all operand registers | |
| | and destination register. | |
| Integer | 32 entries with 16 read ports | 32 entries with 4 read ports |
| Map | and 8 write ports. | and 1 write port. |
| Logic | | Optionally, the pipeline 500 |
| (e.g., | | may not include integer map |
| Table) | | logic and determine |
| | | dependencies using |
| | | comparator logic. |
| Integer | 16 entries with 3 register | 8 entries with 3 register |
| Queue | operands, supporting dual | operands. The IQ may |
| (IQ) | instruction issue | contain both integer and |
| | | vector instructions. |
| Simple | 16 entries with 1 register | None. |
| Queue | operand, supporting dual | |
| (SQ) | instruction issue. | |
| Address | 16 entries with 2 integer | 8 entries with 2 register |
| Queue | register operands for address | operands. The AQ may |
| (AQ) | generate. The AQ may | include a single issue port or |
| | include parallel issue logic for | load or store instructions, |
| | load and store instructions. | queued in-order. Entries |
| | Entries may be released as | may be released at |
| | instructions are issued. | graduation. |
| Vector | 16 entries with 3 register | (Vector instructions issued |
| Queue | operands, supporting dual | from IQ) |
| (VQ) | instruction issue. Entries can | |
| | be linked as “twins” for more | |
| | complex instructions. | |
| Vector | 64 entries with 12 read ports | 64 entries with 3 read ports |
| Map | and 8 write ports. | and 1 write port. |
| Logic | | Optionally, the pipeline 500 |
| (e.g., | | may not include integer map |
| Table) | | logic and determine |
| | | dependencies using |
| | | comparator logic. |
| Integer | 96 × 64-bit physical registers, | 64 × 64-bit physical registers, |
| Register | 8 read ports, 4 write ports. | 2 read ports, 1 write port. |
| File | | As another design option to |
| | | further reduce complexity, 32 × |
| | | 64 bit physical registers, 2 |
| | | read ports, 1 write port. |
| Vector | 96 × 128-bit physical | 96 × 128-bit physical |
| Register | registers, 8 read ports, 4 | registers, 1 read port, 1 write |
| File | write ports. | port. |
| Integer | 2 integer ALUs, including | 1 integer ALU, including |
| ALUs | shifter as well as 2 simple | shifter. |
| | integer ALUs that have one | |
| | register operand. | |
| Address | Includes load address | Includes address generate |
| Genera- | generate logic and store | logic, e.g., as a single unit |
| tion | address generate logic, | with lesser complexity than |
| | which may be separate | the load and store address |
| | dedicated logic. | logic of the high performance |
| | | pipeline 500. |
| Load | 24 entry Content | 8 entry CAM in Address |
| Matrix | Addressable Memory (CAM) | Queue compares indexes. |
| | for detecting dependencies in | Optionally, the pipeline 500 |
| | load instructions | may not include a load matrix |
| Store | 16 entry CAM for detecting | and the store matrix may be |
| Matrix | dependencies in store | simplified from the pipeline |
| | instructions | 400. |
| Load | 24 entry Random Access | Instructions are replayed by |
| Address | Memory (RAM) for replaying | re-issuing the, through the |
| Stack | load instructions | Address Queue. |
| Store | 16 entry RAM for replaying | |
| Address | store instructions. | |
| Stack | | |
| Data | 32 KB data cache. | The pipeline 500 may share |
| Cache | | the same data cache as the |
| | | pipeline 400. |
| Vector | Supports execution of two | The pipeline 500 may |
| Execu- | vector instructions in parallel, | selectively use a vector |
| tion | and may include 2 floating | execution unit implemented |
| Unit | point multipliers and 2 | in the pipeline 400. |
| | floating point address. The | Duplicate vector execution |
| | vector execution units may | units are power down to |
| | also include a simple Single- | reduce leakage. |
| | Instruction-Multiple-Data | |
| | (SIMD) unit, a complex | |
| | SIMD unit, and cryptography | |
| | units. | |

As discussed above, the pipeline 400 and the pipeline 500 may support instruction execution throughput of differing rates. The instruction unit 210, when issuing instructions to the high-performance pipeline 400, may align instructions in multiple lanes for issue each cycle. When issue instructions to the low-power pipeline 500, the instruction unit 210 issue instructions at a lesser rate, e.g., one instruction per cycle. In this case, the instruction unit 210 may power down instruction issue circuitry supporting issue at the high-performance rate, e.g., by powering down the instruction buffer and wide instruction path in stages N3 and N4. The instruction unit 210 may additionally reduce a fetch rate of instructions consistent to the rate of instruction issuance for the pipeline 500 and use a multiplexer to select a next instruction from the instruction register.

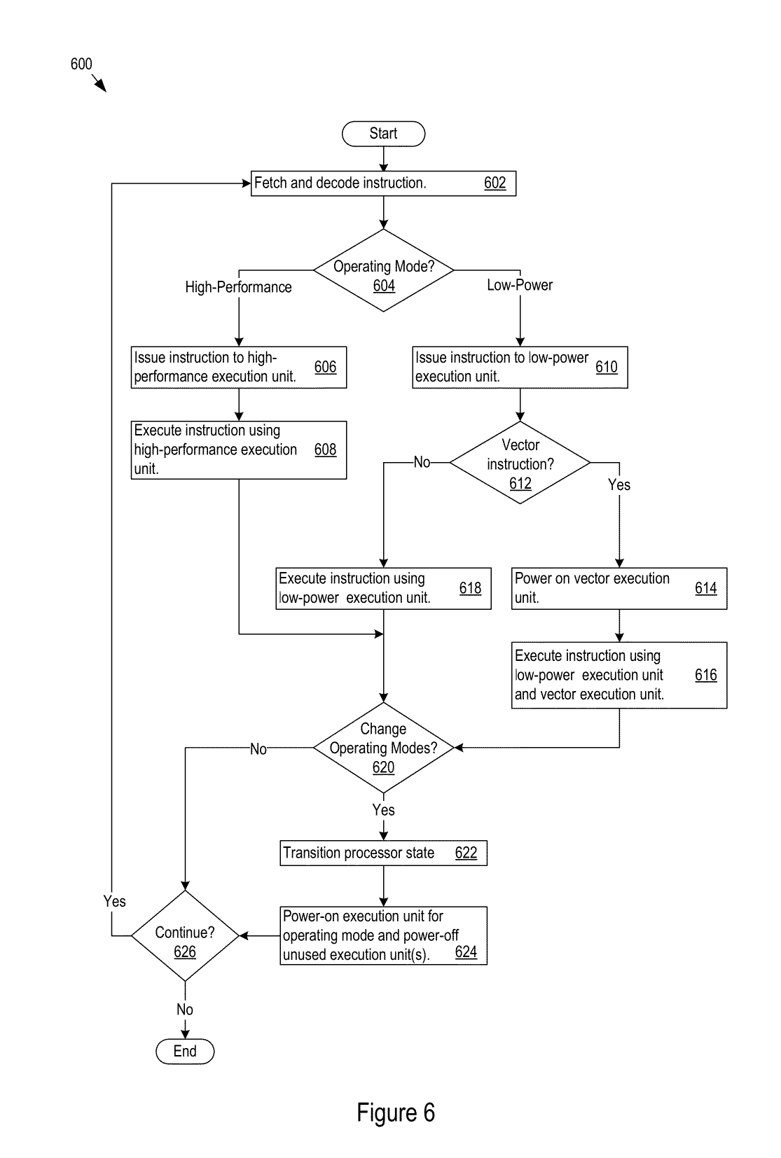

FIG. 6 shows an example of logic 600 that the electronic device 100 may implement. The electronic device 100 may implement the logic 600 in hardware as a processor core 110, for example, or additionally in combination with software or firmware.

The processor core 110 may fetch and decode a program instruction (602). The processor core 110 may determine an execution unit to use for executing the program instruction, which may depend on the operating mode that the processor core 110 is operating in (604). Two exemplary modes include a high-performance mode with increased performance and throughput and a low-power mode with less dynamic power consumption than the high-performance mode. When operating in a high-performance mode, the processor core 110 may issue the program instruction to an execution pipeline implemented by a high-performance execution unit (606). The high performance execution unit may execute the program instruction (608). When operating in a low-power mode, the processor core 110 may issue the program instruction to an execution pipeline implemented by a low-power execution unit (610). When operating in a particular operating mode, the processor core 110 may power-down execution units in the processor core 110 unused for the particular operating mode.

The processor core 110 may selectively use, e.g., power-on, a particular functional component of an unused execution unit. One example is shown in FIG. 6. When operating in the low-power mode, the processor core 110 may power-down the high-performance execution unit and execute instructions using the low-power execution unit. The low-power execution unit may not include a function component that supports execution of vector operations, e.g., a vector execution unit. Upon determining an instruction is a vector instruction (612), the processor core 110 may power-on a vector execution unit implemented by the high-power execution unit (614) and execute the vector instruction using the lower-power execution and the vector execution unit, selectively powered-on to support execution of the vector instruction (616). When the program instruction is not a vector instruction, the processor core 110 may execute the program instruction using the low-power execution unit without powering on the vector execution unit (618).

The processor core 110 may determine to transition between operating modes (620). For example, the processor core 110 may receive a control signal instructing the processor core 110 to transition from a first operating mode (e.g., high-performance) to a second operating mode (e.g., low-power). The control signal may be sent by high-level logic, such as an operating system or other software executing on the electronic device 100. The high-level logic (e.g., operating system) may access performance measurement data from hardware implemented in the processor core 110, and determine to transition between operating modes when a certain performance thresholds are passed. The processor core 110 may receive the control signal as a result of a change in performance requirements of the electronic device 100, e.g., upon executing a program or program thread requiring a particular performance requirement. One such example is upon launching a video rendering application by the electronic device 100. The processor core 110 may receive the control signal as a result of a change in energy supply for the electronic device 100, e.g., transitioning to a low-power mode when a limited energy supply (e.g., battery) powers the electronic device or when the limited energy supply falls below a particular threshold.

In some variations, the processor core 110 determines to transition operating modes based on one or more transition criteria. Such criteria may specify transitioning between operating modes based on a measured characteristic or state of the processor core 110, such as when a measured temperature or voltage of the processor core 110 exceeds a threshold value or when a memory element exceeds a threshold fill capacity.

The transition criteria may specify the processor core 110 transitioning operating modes according to performance statistics. For example, the processor core 110 may determine to transition operating modes by monitoring any number of performance statistics. The processor core 110 may transition between operating modes when the number of instructions in a pipeline or particular circuitry exceeds or falls below a particular threshold. The threshold may be measured as any function of a number of instructions, including the number of instructions presently in the pipeline, the average number of instructions executed or issued over a predetermined period of time, the maximum or minimum number of instructions in the pipeline over an amount of time, etc. Accordingly, the performance statistics specified in the transition criteria may reflect instantaneous performance or performance over time of the processor core 110 or particular circuitry within the processor core (e.g., a particular pipeline execution unit). As another example of transition criteria, the processor core 110 may transition processor states when average use (e.g., as measured in instructions processed, power usage, or any other metric) exceeds a pre-set threshold. In some implementations, the transition criteria may be based on a number of vector instructions present in a pipeline or in the instruction cache 211, e.g., transition to a high-performance operating mode when the number of vector instructions exceeds a predetermined threshold.

In some variations, the processor core 110 determines to transition between operating modes without software intervention, e.g., without instruction from operating system software. The processor core 110 may determine to transition operating modes without software intervention or instruction according to any of the transition criteria described above. In doing so, the processor core 110 may perform high-speed, hardware-based transitions based on power and processing demand, which may increase the power and energy efficiency of the processor core 110.

To transition from a first operating mode to a second operating mode, the processor core 110 may transition the processor state between execution units (622), e.g., between memory elements specific to the execution units. As discussed above, processor core 110 may implement memory elements storing processor state that are commonly accessible to execution units in the processor core 110. As such, the processor core 110 may transition the processor state between execution units without having to transfer the memory contents of the commonly accessible memory elements. Even for memory elements specific to an execution unit, e.g., a register file or control registers, the processor core 110 may quickly and efficiently transition these memory contents between execution units located proximately within a processor core 110, e.g., without having to access a system interface 208 or system busses to transfer data between processor cores or memory elements external to the processor core 110. In that regard, the processor core 110 may transfer processor state without the latency associated with a software context-switch instruction. The processor core 110 may also power-on the execution unit(s) associated with the second operating mode, power-down the execution unit(s) associated with the first operating mode (624), and continue to execute instructions (626).

The methods, devices, systems, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Various implementations have been specifically described. However, many other implementations are also possible.

What is claimed is:

1. A system comprising:
a processor core comprising:
a first execution unit within the processor core; and
a second execution unit within the processor core, the second execution unit different from the first execution unit; and
where the processor core is configured to:
operate in a first mode by using the first execution unit and powering down the second execution unit; and
operate in a second mode by using the second execution unit and powering down the first execution unit.

2. The system of claim 1, where the processor core further comprises:
an instruction unit shared by both the first and second execution units, the instruction unit configured to:
fetch an instruction; and
when the processor core operates in the first mode:
issue the instruction to the first execution unit of the processor core; and
when the processor cores operates in the second mode:
issue the instruction to the second execution unit of the processor core.

3. The system of claim 2, where the instruction unit is configured to issue instructions at a first rate when operating in the first mode and at a second rate when operating in the second mode, where the first rate is greater than the second rate.

4. The system of claim 1, where:
the first execution unit comprises a first register file specific to the first execution unit; and
the second execution unit comprises a second register file specific to the second execution unit.

5. The system of claim 4, where the processor core is further configured to:
transition from operating in the first mode to operating in the second mode by copying a register value stored in the first register file into the second register file.

6. The system of claim 1, where the processor core further comprises a common register file shared by both the first and second execution units.

7. The system of claim 6, where the processor core is further configured to:
transition from operating in the first mode to operating in the second mode without changing content of the common register file.

8. The system of claim 1, where the processor core further comprises:
a data cache shared by both the first and second execution units.

9. The system of claim 8, where the processor core is further configured to:
transition from operating in the first mode to operating in the second mode without flushing the data cache.

10. The system of claim 1, where the first execution unit comprises a vector execution unit; and
where the processor core is configured to operate in the second mode by using the second execution unit and selectively powering on the vector execution unit of the first execution unit in order to execute a vector instruction.

11. The system of claim 1, where the processor core further comprises a common system interface shared by both the first and second execution units.

12. A method comprising:
in a processor core:
obtaining a program instruction for execution by the processor core;
determining an operating mode for the processor core; and
when the processor core operates in a first mode:
issuing the instruction to a first execution unit implemented within the processor core; and
maintaining a second execution unit also implemented within the processor core in a power-down mode; and
when the processor core operates in a second mode:
issuing the instruction to the second execution unit; and
maintaining the first execution unit in a power-down mode.

13. The method of claim 12, further comprising:
determining to transition from operating in the first mode to operating in the second mode, and in response:
transitioning a processor state of the processor core from the first execution unit to the second execution unit.

14. The method of claim 13, comprising transitioning the processor state without flushing a data cache shared by the first and second execution units.

15. The method of claim 13, further comprising:
implementing a common register file shared by the first and second execution units implemented in the processor core; and
where transitioning the processor state comprises transitioning the processor state from the first execution unit to the second execution unit without transferring content of the common register file.

16. The method of claim 12, further comprising:
implementing a instruction cache shared by both the first and second execution units implemented within the processor core.

17. A device comprising:
a processor core comprising:
a first execution unit comprising a first functional component supporting a superscalar pipeline;
a second execution unit comprising a second functional component supporting a simple scalar pipeline; and
where the processor core is configured to:
operate in a first performance mode by using the first execution unit and powering down second execution unit; and
operate in a second performance mode by using the second execution unit and powering down the first execution unit.

18. The device of claim 17, where the processor core further comprises:
an instruction unit shared by both the first and second execution units, the instruction unit configured to:
fetch an instruction; and
when the processor core operates in the first performance mode:
issue the instruction to the first execution unit of the processor core; and
when the processor cores operates in the second performance mode:
issue the instruction to the second execution unit of the processor core.

19. The device of claim 17, where:
the first execution unit comprises a first register file specific to the first execution unit and the superscalar pipeline; and
the second execution unit comprises a second register file specific to the second execution unit and the simple scalar pipeline.

20. The device of claim 19, where the processor core is further configured to:
transition from operating in the first performance mode to operating in the second performance mode by copying a register value stored in the first register file into the second register file.
